(19) United States
(12) Patent Application Publication
(10) Pub. No.: US 2026/0254531 A1
(43) Pub. Date: Aug. 27, 2026

(54) MEASUREMENT METHOD, DETERMINATION METHOD, AND MEASUREMENT SYSTEM

(71) Applicants: NTT, Inc., Tokyo (JP); ANRITSU CORPORATION, Kanagawa (JP)

(72) Inventors: Hiroshi SHIBATA, Tokyo (JP); Kohei WATANABE, Tokyo (JP); Hiroshi YAMAMOTO, Tokyo (JP); Ken ITO, Tokyo (JP); Motohiro BANNO, Kanagawa (JP); Shinji MORIMOTO, Kanagawa (JP); Yosho KANDA, Kanagawa (JP)

(21) Appl. No.: 19/444,342

(22) Filed: Jan. 9, 2026

(30) Foreign Application Priority Data
Feb. 21, 2025 (JP) 2025-026574

(51) Int. Cl. H04B 10/079

(52) U.S. Cl. CPC H04B 10/07953

(57) ABSTRACT

In an experimental environment including a test system that adds an ASE noise to signal light between a transmitting transponder and a receiving transponder connected in a back-to-back manner, OSNR of the signal light and BER of the signal light received by the receiving transponder are measured while changing a ratio of the signal light to the ASE noise, SNR_{ASE_test} of the signal light to which the ASE noise is added is obtained, and total SNR_{TOT} including the test system and the transponders is obtained. SNR_{TRX} indicating an amount of the noise in the transponders is obtained. In a commercial environment in which the test system is provided at upstream of the receiving transponder between the transmitting transponder and the receiving transponder connected via an optical transmission network, the same measurement as in the experimental environment is performed, and GSNR of the optical transmission network is obtained.

### TECHNICAL FIELD

The present disclosure relates to a measurement method and a determination method.

### BACKGROUND ART

An optical transmission network is an infrastructure that supports high-speed and large-capacity data transmission, and functions as a base for various services and applications. Management of a communication quality plays an important role in improving a reliability of the network. A generalized signal-to-noise ratio (GSNR) is used as one index for evaluating the communication quality of the optical transmission network. GSNR is an index obtained by extending an optical signal-to-noise ratio (OSNR), and is an index obtained by considering an amount of non-linear noises due to nonlinearity of a fiber, in addition to a linear noise (for example, amplified spontaneous emission (ASE) noise).

### RELATED ART DOCUMENT

### Non Patent Document

[Non Patent Document 1]“Vertical Compatible DWDM Application for Optical Amplifier Submarine Cable System”, JT-G977.1, Telecommunications and Internet Federation of Japan, p. 17
[Non Patent Document 2] Toru Mano, et al., “Modeling Transceiver BER-OSNR Characteristic for QoT Estimation in Short-Reach Systems,” 2023 International Conference on Optical Network Design and Modeling (ONDM)

### DISCLOSURE OF THE INVENTION

### Problem that the Invention is to Solve

With the opening of the optical transmission network, it is assumed that various transponders are connected to the optical transmission network. The opening here refers to a case where a communication carrier provides an optical transmission network and a user independently procures a transponder or a transceiver installed at both ends of an optical path. In this case, the communication carrier needs to grasp a state of the optical transmission network excluding the transponder and to determine an abnormality or a deterioration of the communication quality, and the measurement of GSNR of the optical transmission network is required.

SNR_{TOT}, defined as the entire combination of the optical transmission network, a transmission end (including a transmitting transponder), and a reception end (including a receiving transponder) can be represented as a combination of GSNR of the optical transmission network and SNR_{TRX} of the transmission end and the reception end.

In Non Patent Document 2, a method of connecting transponders on a transmission side and a reception side in a back-to-back manner to obtain SNR_{TRX} at a reception end is described. In Non Patent Document 2, a Pre-Forward Error Correction Bit Error Rate (PreFEC BER, hereinafter referred to as BER) of a signal light received by the transponder is measured to calculate SNR_{TOT}.

However, in a case where the error rate is low and BER cannot be measured at the reception end, SNRTOT cannot be calculated, and GSNR cannot be calculated.

The present disclosure has been made in view of the above circumstances, and an object of the present disclosure is to obtain GSNR of an optical transmission network.

### Means for Solving the Problem

According to an aspect of the present disclosure, there is provided a method for measuring a GSNR of an optical transmission network, the measurement method including: measuring, in a first configuration in which a test unit that adds an ASE noise to first signal light output from a transmitter is provided between the transmitter and a receiver directly connected without going through the optical transmission network, a first OSNR of the first signal light and a first BER of the first signal light received by the receiver while changing a ratio of the first signal light to the ASE noise; obtaining a first SNR of the first signal light to which the ASE noise is added by the test unit from the first OSNR; obtaining a second SNR of the entire first configuration from the first BER; obtaining an amount of noises in the transmitter and the receiver from a relationship between a reciprocal of the first SNR and a reciprocal of the second SNR when the ratio of the first signal light to the ASE noise is changed; measuring, in a second configuration in which a test unit that adds an ASE noise to second signal light received by the receiver is provided at upstream of the receiver between a transmitter and the receiver connected via the optical transmission network, a second OSNR of the second signal light and a second BER of the second signal light received by the receiver while changing a ratio of the second signal light to the ASE noise; obtaining a third SNR of the second signal light to which the ASE noise is added by the test unit from the second OSNR; obtaining a fourth SNR of the entire second configuration from the second BER; obtaining an amount of noises in a configuration including the optical transmission network, the transmitter, and the receiver from a relationship between a reciprocal of the third SNR and a reciprocal of the fourth SNR when the ratio of the second signal light to the ASE noise is changed; and obtaining the GSNR of the optical transmission network by subtracting the amount of the noise in the transmitter and the receiver from the amount of the noise in the configuration.

According to another aspect of the present disclosure, there is provided a method for determining an abnormality of an optical transmission network, the determination method including: obtaining a GSNR of the optical transmission network by the measurement method described above; and determining the abnormality of the optical transmission network by comparing the GSNR of the optical transmission network with a reference value.

According to still another aspect of the present disclosure, there is provided a measurement system that measures a GSNR of an optical transmission network, the measurement system including: a first configuration in which a test unit that adds an ASE noise to first signal light output from a transmitter is provided between the transmitter and a receiver directly connected without going through the optical transmission network; and a second configuration in which a test unit that adds an ASE noise to second signal light received by the receiver is provided at upstream of the receiver between a transmitter and the receiver connected via the optical transmission network, in which in the first configuration, a first OSNR of the first signal light and a first BER of the first signal light received by the receiver are measured while changing a ratio of the first signal light to the ASE noise, a first SNR of the first signal light to which the ASE noise is added by the test unit is obtained from the first OSNR, a second SNR of the entire first configuration is obtained from the first BER, and an amount of noises in the transmitter and the receiver is obtained from a relationship between a reciprocal of the first SNR and a reciprocal of the second SNR when the ratio of the first signal light to the ASE noise is changed, and in the second configuration, a second OSNR of the second signal light and a second BER of the second signal light received by the receiver are measured while changing a ratio of the second signal light to the ASE noise, a third SNR of the second signal light to which the ASE noise is added by the test unit is obtained from the second OSNR, a fourth SNR of the entire second configuration is obtained from the second BER, an amount of noises in a configuration including the optical transmission network, the transmitter, and the receiver is obtained from a relationship between a reciprocal of the third SNR and a reciprocal of the fourth SNR when the ratio of the second signal light to the ASE noise is changed, and the GSNR of the optical transmission network is obtained by subtracting the amount of the noise in the transmitter and the receiver from the amount of the noise in the configuration.

### Advantage of the Invention

According to the present disclosure, it is possible to obtain GSNR of an optical transmission network.

### BRIEF DESCRIPTION OF THE DRAWINGS

FIG. 1 is a flowchart illustrating an example of a flow of a process of a GSNR measurement method.

FIG. 2 is a diagram illustrating an example of a configuration of an experimental environment.

FIG. 3 is a diagram illustrating an example of a configuration of a commercial environment.

FIG. 4 is a flowchart illustrating an example of a flow of a process of measuring SNR_{TRX}.

FIG. 5 is a diagram illustrating an example in which measurement values of SNR_{ASE_test} and SNR_{TOT} are plotted.

FIG. 6 is a flowchart illustrating an example of a flow of a process of measuring GSNR_{DUT}.

FIG. 7 is a diagram illustrating an example in which measurement values of SNR_{ASE_test} and SNR_{TOT} are plotted.

FIG. 8 is a diagram illustrating an example in which measurement values of 1/OSNR and 1/SNR_{TOT} are plotted.

FIG. 9 is a diagram illustrating an example of SNR_{TRX} acquired in advance.

FIG. 10 is a flowchart illustrating an example of a flow of a process of a normality check at a time of opening a path.

### BEST MODE FOR CARRYING OUT THE INVENTION

### Measurement Method for GSNR

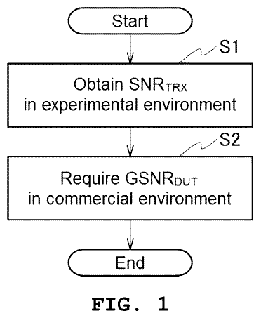

An example of a measurement method for GSNR according to the present embodiment will be described with reference to the flowchart in FIG. 1.

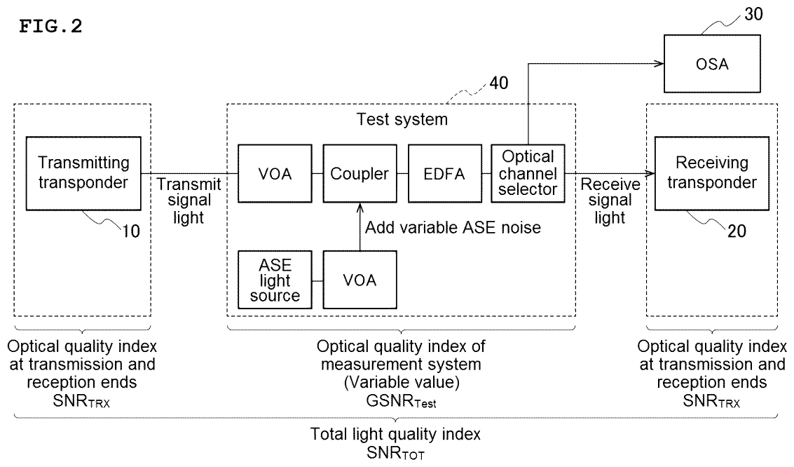

In step S1, BER and OSNR are measured while changing a ratio of signal light to an ASE noise in an experimental environment illustrated in FIG. 2, SNR_{TOT} and SNR_{ASE_test} are obtained from the measured BER and OSNR, and 1/SNR_{TRX} is obtained from the approximation curve derived by plotting 1/SNR_{TOT} and 1/SNR_{ASE_test}. SNR_{TOT} is an index indicating an amount of total noises obtained by combining a test system 40, a transmitting transponder 10, and a receiving transponder 20. SNR_{ASE_test} is an index indicating a quality of the signal light to which the ASE noise is added in the test system 40. SNR_{TRX} is an index indicating an amount of noises on the transmitting transponder 10 and the receiving transponder 20.

In the experimental environment, the transponders 10 and 20 of the same type as a transponder used in a commercial environment are connected in a back-to-back manner, and the test system 40 is inserted between the transponders 10 and 20. The test system 40 adds the ASE noise to the signal light output from the transmitting transponder 10.

SNR_{TOT} of the entire experimental environment is represented by the following equation.

$$\begin{matrix}\frac{1}{{SNR}_{TOT}} = \frac{1}{{GSNR}_{Test}} + \frac{1}{{SNR}_{TRX}} \\ \approx \frac{1}{{SNR}_{ASE \_ test}} + \frac{1}{{SNR}_{TRX}}\end{matrix}$$

Since it is assumed that GSNR_{Test} of the test system 40 can ignore a non-linear noise component, GSNR_{Test} can be approximated to SNR_{ASE_test}. Since SNR_{TOT} is decreased in a case where a ratio of the ASE noise is increased, the reciprocal 1/SNR_{TOT} is increased. In a case where the ASE noise is sufficiently small, 1/SNR_{TOT} is dominated by 1/SNR_{TRX}.

Therefore, 1/SNR_{TOT} in a case where the ASE noise is sufficiently small can be regarded as 1/SNR_{TRX}.

In step S1, 1/SNR_{TRX} is obtained from a relationship between 1/SNR_{TOT} and 1/SNR_{ASE_test} obtained while changing the ratio of the signal light to the ASE noise.

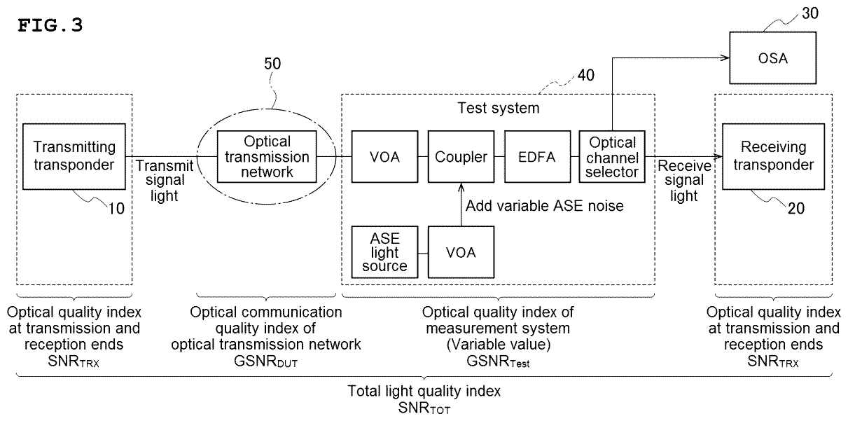

In step S2, BER and OSNR are measured while changing a ratio of signal light to an ASE noise in a commercial environment illustrated in FIG. 3, SNR_{TOT} and SNR_{ASE_test} are obtained from measured BER and OSNR, an amount of noises of a configuration including an optical transmission network 50, the transmitting transponder 10, and the receiving transponder 20 is obtained from the approximation curve derived by plotting 1/SNR_{TOT} and 1/SNR_{ASE_test}, and an amount of noises of the transmitting transponder 10 and the receiving transponder 20 obtained in step S1 is subtracted from the noise of the configuration to obtain GSNR_{DUT}. Here, SNR_{TOT} is an index of an amount of total noises contributed by the optical transmission network 50, the test system 40, the transmitting transponder 10, and the receiving transponder 20. GSNR_{DUT} is one index of an optical communication quality of the optical transmission network 50.

In the commercial environment where the transponders 10 and 20 are connected via the optical transmission network 50, the test system 40 is inserted between the network 50 and the transponder 20. The optical transmission network 50 includes an optical fiber and an optical transmission device such as a reconfigurable optical add/drop multiplexer (ROADM) or an amplifier, but is not illustrated in FIG. 3.

SNR_{TOT} of the entire commercial environment is represented by the following equation.

$$\begin{matrix}\frac{1}{{SNR}_{TOT}} = \frac{1}{{GSNR}_{DUT}} + \frac{1}{{GSNR}_{Test}} + \frac{1}{{SNR}_{TRX}} \\ \approx \frac{1}{{GSNR}_{DUT}} + \frac{1}{{SNR}_{ASE \_ test}} + \frac{1}{{SNR}_{TRX}}\end{matrix}$$

In the same manner as step S1, in step S2, 1/GSNR_{DUT}+1/SNR_{TRX} is obtained from a relationship between 1/SNR_{TOT} and 1/SNR_{ASE_test} obtained while changing the ratio of the signal light to the ASE noise, and 1/GSNR_{DUT} is obtained from a difference between 1/GSNR_{DUT}+1/SNR_{TRX} and 1/SNR_{TRX} obtained in step S1.

SNR_{TOT} and SNR_{ASE_test} are obtained by performing measurement while changing the ratio of the signal light to the ASE noise, and 1/SNR_{TRX} or 1/GSNR_{DUT}+1/SNR_{TRX} is obtained from the approximation curve derived from SNR_{TOT} and SNR_{ASE_test}, whereby even in a case where BER of an optical signal of the transponders 10 and 20 of the back-to-back configuration or the transponders 10 and 20 connected via the optical transmission network 50 is low or an error rate of the optical signal is low and BER cannot be measured, SNR_{TOT} of the entire configuration can be obtained to obtain GSNR_{DUT}.

### Measurement of SNR_{TRX}

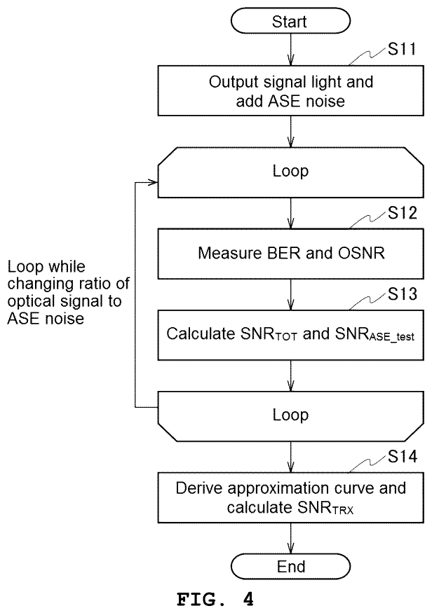

An example of a flow of a process of step S1 of obtaining SNR_{TRX} will be described with reference to the flowchart in FIG. 4.

In step Sl1, the transmitting transponder 10 outputs signal light, and the test system 40 adds an ASE noise to the signal light. In the test system 40, an intensity of the signal light is adjusted by a variable optical attenuator (VOA), an intensity of the ASE noise output by an ASE light source is adjusted by the VOA, and the signal light and the ASE noise are multiplexed by a coupler. The signal light to which the ASE noise is added is amplified by an Erbi um-Doped Fiber Amplifier (EDFA) and is input to the receiving transponder 20 and an optical spectrum analyzer (OSA) 30 via an optical channel selector.

In step S12, BER of the signal light received by the receiving transponder 20 is measured by a measurement device, and OSNR is measured by the OSA 30.

In step S13, SNR_{TOT} and SNR_{ASE_test} are calculated from BER and OSNR.

In order to calculate SNR_{TOT} from BER, the following equation different for each modulation method is used.

In a case of

$$DP - 16 QAM ,$$

$$BER = \frac{3}{8} erfc ( \sqrt{\frac{{SNR}_{TOT}}{10}} )$$

In a case of

$$DP - QPSK ,$$

$$BER = \frac{3}{8} erfc ( \sqrt{\frac{{SNR}_{TOT}}{2}} )$$

Here, erfc represents a complementary error function. The following equation is used to calculate SNR_{ASE_test} from OSNR.

$${SNR}_{ASE \_ test} = \frac{Δ f}{{R}_{s} η} OSNR$$

Here, Δf is a resolution bandwidth of the OSA, Rs is a baud rate, and η is a conversion coefficient. All of the values are known, and for example, Δf=12.5 GHz, Rs=60 Gbaud, 30 Gbaud, and η=1.1.

The processes of steps S12 and S13 are repeated while changing the ratio between the signal light and the ASE noise.

In step S14, SNR_{TOT} and SNR_{ASE_test} are obtained by performing measurement while changing the ratio between the signal light and the ASE noise, and 1/SNR_{TRX} is calculated from the approximation curve derived from SNR_{TOT} and SNR_{ASE_test}.

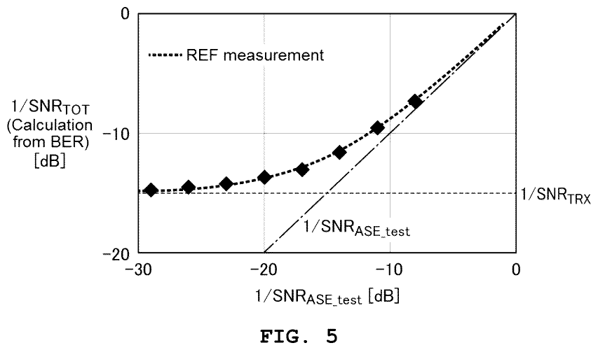

FIG. 5 illustrates an example in which measurement values are plotted. In FIG. 5, 1/SNR_{ASE_test} is plotted on a horizontal axis, and 1/SNR_{TOT} is plotted on a vertical axis.

A lower limit value of 1/SNR_{TOT} in FIG. 5 is obtained as 1/SNR_{TRX} from an approximation curve of the measurement value.

### Measurement of GSNR_{DUT}

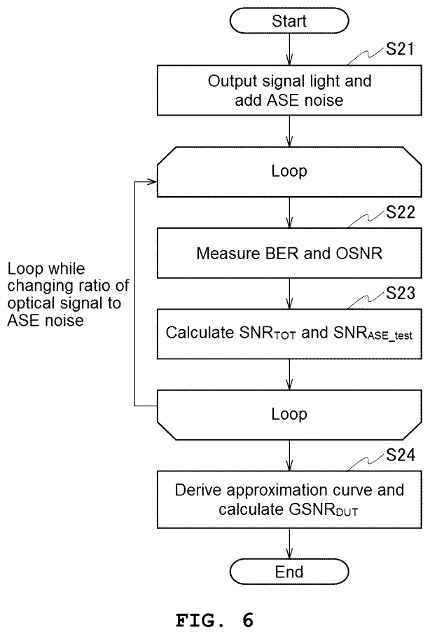

An example of a flow of the process in step S2 of obtaining GSNR_{DUT} will be described with reference to the flowchart in FIG. 6.

In step S21, the transmitting transponder 10 outputs signal light, and the test system 40 adds an ASE noise to the signal light via the optical transmission network 50.

In step S22, BER of the signal light received by the receiving transponder 20 is measured by a measurement device, and OSNR is measured by the OSA 30.

In step S23, SNR_{TOT} and SNR_{ASE_test} are calculated from BER and OSNR. Here, SNR_{TOT} is total SNR obtained by combining the optical transmission network 50, the test system 40, the transmitting transponder 10, and the receiving transponder 20.

The processes of steps S22 and S23 are repeated while changing a ratio between the signal light and the ASE noise.

In step S24, SNR_{TOT} and SNR_{ASE_test} are obtained by measurement while changing the ratio of the signal light to the ASE noise, 1/GSNR_{DUT}+1/SNR_{TPX} is calculated from the approximation curve derived from SNR_{TOT} and SNR_{ASE_test}, and a difference with 1/SNR_{TRX} obtained in step S1 is obtained to calculate GSNR_{DUT}.

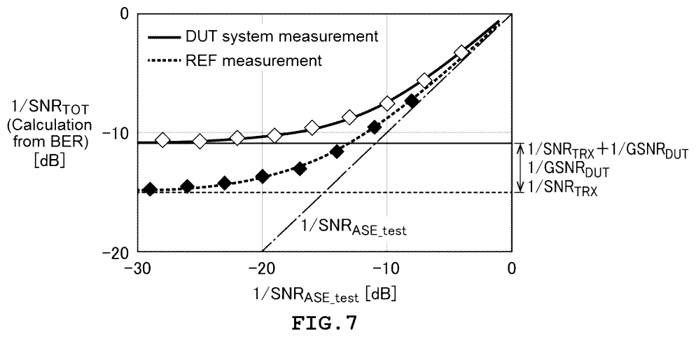

FIG. 7 illustrates an example in which measurement values are plotted. In FIG. 7, 1/SNR_{ASE_test} is plotted on a horizontal axis, and 1/SNR_{TOT} is plotted on a vertical axis. A lower limit value of 1/SNR_{TOT} in FIG. 7 is obtained as 1/GSNR_{DUT}+1/SNR_{TRX} from an approximation curve of the measurement value.

GSNR_{DUT} is obtained from a difference between 1/GSNR_{DUT}+1/SNR_{TRX} obtained from the approximation curve and 1/SNR_{TRX} obtained in step S1.

Among the processes illustrated in FIGS. 4 and 6, a process of calculating various indexes can be executed by a computer including a processor and a memory.

### Calculation of Conversion Coefficient

The conversion coefficient η in a case where OSNR is converted into SNR_{ASE_test} may be obtained from measurement values of BER and OSNR. Hereinafter, an example of obtaining the conversion coefficient η from the measurement value will be described.

In steps S12 and S13 in FIG. 4, a set of 1/OSNR and 1/SNR_{TOT} obtained by measurement while changing the ratio of the signal light to the ASE noise is recorded as α and β, and the conversion coefficient η is calculated by the following equation.

$$η = \frac{Δ f}{{R}_{s}} \frac{\sum ( β - \overline{β} ) ( α - \overline{α} )}{\sum {( α - \overline{α} )}^{2}}$$

$$α = \frac{1}{OSNR} , β = \frac{1}{{SNR}_{TOT}}$$

α is ASE noise of an optical signal measured by the OSA 30, and β is noise that can be extracted from BER of the optical signal. α (bar above) and β (bar above) are each an average value of α and β.

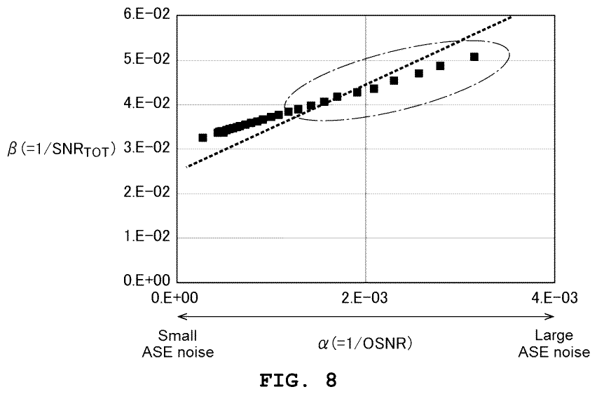

FIG. 8 illustrates an example of measurement data with a on a horizontal axis and β on a vertical axis. A broken line in FIG. 8 is a straight line of the conversion coefficient η=1.1. The conversion coefficient η is calculated from a slope of the straight line of the measurement data in a region in which the value α with which the ASE noise is dominant is large. The slope of the straight line of the measurement data is ηRs/Δf.

By using the conversion coefficient η obtained from a set of 1/OSNR and 1/SNR_{TOT} obtained by measurement instead of the defined value (η=1.1), it is possible to estimate GSNR with higher accuracy.

### Abnormality Determination Method

An example in which a normality check at a time of opening of an optical path and a quality deterioration check after the optical path is opened in the optical transmission network are performed by using the GSNR measurement method of the present embodiment will be described.

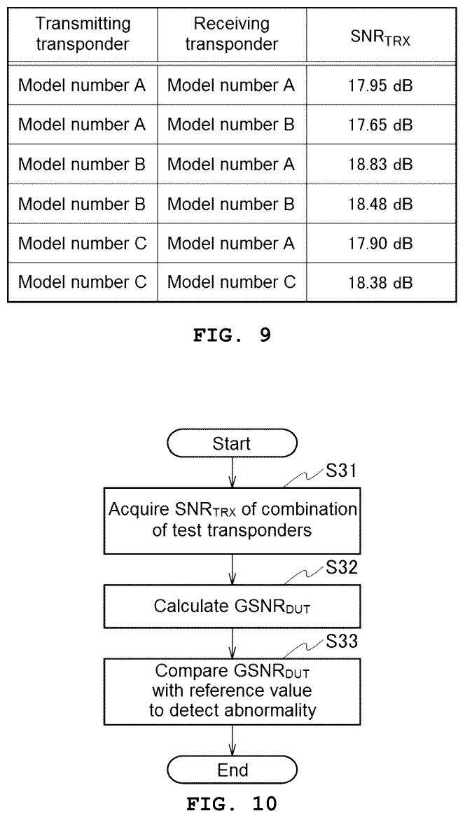

As a preliminary preparation, SNR_{TRX} is measured for a combination of several types of transponders in an experimental environment. The method illustrated in the flowchart in FIG. 4 can be used to measure SNR_{TRX}. FIG. 9 illustrates an example of SNR_{TRX} acquired in advance. FIG. 9 illustrates model numbers of a transmitting transponder and a receiving transponder and SNR_{TRX} measured for each combination of the model numbers.

In addition, as a preliminary preparation, a value of GSNR of the optical transmission network in a normal state in a commercial environment is acquired as a reference value. For example, a value of GSNR in a normal state is acquired by modeling an optical transmission network in the commercial environment and using an optical transmission network simulator.

An example of a flow of the process of the normality check at a time of opening the path will be described with reference to the flowchart in FIG. 10. Test transponders are connected to both ends of an optical path as a target in the commercial environment, the test system 40 is inserted at upstream of the transponder on the reception side, and then the process of the flowchart in FIG. 10 is executed.

In step S31, SNR_{TRX} corresponding to a combination of the test transponders is acquired. SNR_{TRX} may be calculated by using the method illustrated in the flowchart in FIG. 4, or may be acquired from the table in FIG. 9 acquired in advance.

In step S32, 1/SNR_{TRX}+1/GSNR_{DUT} is calculated by using the method illustrated in the flowchart in FIG. 6, and GSNR_{DUT} is calculated by using SNR_{TRX} acquired in step S31.

In step S33, calculated GSNR_{DUT} is compared with a reference value of GSNR, and it is determined that the measurement is normal in a case where a difference is within an assumed measurement uncertainty (for example, ±1.0 dB), and the measurement is abnormal in a case where GSNR_{DUT} is equal to or greater than an assumed error.

In a case where the determination result is normal, the test transponder and the test system 40 are detached from the commercial environment, and a transponder prepared by a user is connected to provide the optical path. The test transponder may be used as it is, or the test system 40 may not be detached.

For the quality deterioration check after the optical path is opened, GSNR_{DUT} calculated in step S32 is acquired as GSNR_{DUT-Normal} which is a reference value of GSNR. In order to reduce an influence of a measurement uncertainty, GSNR_{DUT} may be measured a plurality of times in step S32, and an average value thereof may be used as GSNR_{DUT-Normal}.

In the quality deterioration check after the optical path is opened, GSNR_{DUT} is calculated by using the process of step S32 or the technique described in Non Patent Document 2, and calculated GSNR_{DUT} and GSNR_{DUT-Normal} are compared with each other in the same manner as in step S33. In a case where a difference is equal to or greater than an assumed error, it is determined that an abnormality has occurred.

In Non Patent Document 2, BER of the signal light received by the transponder is measured without inserting the test system 40, SNR_{TOT} is calculated from BER, and GSNR_{DUT} is calculated by using SNR_{TRX} obtained in advance. In the technique of the Non Patent Document 2, in a case where BER is low or the error rate of the optical signal is low and BER cannot be measured, SNR_{TOT} cannot be calculated. Meanwhile, in a case where BER is low, it is considered that there is no problem in the quality of the optical transmission network 50. Therefore, the technique of Non Patent Document 2 may be used in the quality deterioration check after the optical path is opened.

As described above, in the GSNR measurement method of the optical transmission network 50 of the present embodiment, in the experimental environment including the test system 40 that adds the ASE noise to the signal light between the transmitting transponder 10 and the receiving transponder 20 connected in a back-to-back manner, OSNR of the signal light and BER of the signal light received by the receiving transponder 20 are measured while changing the ratio of the signal light to the ASE noise. SNR_{ASE_test} of the signal light to which the ASE noise is added from OSNR is obtained, and total SNR_{TOT} including the test system 40, the transmitting transponder 10, and the receiving transponder 20 is obtained from BER. SNR_{TRX} indicating the amount of noise in the receiving transponder 20 is obtained from the relationship between 1/SNR_{ASE_rest} and 1/SNR_{TOT} in a case where the ratio of the signal light to the ASE noise is changed. In the commercial environment in which the test system 40 is provided at upstream of the receiving transponder 20 between the transmitting transponder 10 and the receiving transponder 20 connected via the optical transmission network 50, the same measurement as in the experimental environment is performed, 1/GSNR+1/SNR_{TRX} is obtained from the relationship between 1/SNR_{ASE_test} and 1/SNR_{TOT}, and 1/SNR_{TRx} is subtracted to obtain the GSNR of the optical transmission network. Accordingly, even in a case where the error rate of the optical signal received by the receiving transponder 20 is low and BER cannot be measured by the receiving transponder 20, BER is measured while changing the ratio of the signal light to the ASE noise in the test system 40. Therefore, SNR_{TOT} of the entire configuration can be calculated, and GSNR of the optical transmission network 50 can be calculated.

By using GSNR of the optical transmission network 50 measured in a normal state as a reference value and comparing GSNR of the optical transmission network 50 with the reference value, it is possible to determine an abnormality of the optical transmission network.

### DESCRIPTION OF REFERENCE NUMERALS AND SIGNS

10, 20: transponder
30: optical spectrum analyzer
40: test system
50: optical transmission network

What is claimed is:

1. A measurement method of a GSNR of an optical transmission network, the measurement method comprising:
measuring, in a first configuration in which a test unit that adds an ASE noise to first signal light output from a transmitter is provided between the transmitter and a receiver directly connected without going through the optical transmission network, a first OSNR of the first signal light and a first BER of the first signal light received by the receiver while changing a ratio of the first signal light to the ASE noise;
obtaining a first SNR of the first signal light to which the ASE noise is added by the test unit from the first OSNR;
obtaining a second SNR of the entire first configuration from the first BER;
obtaining an amount of noises in the transmitter and the receiver from a relationship between a reciprocal of the first SNR and a reciprocal of the second SNR when the ratio of the first signal light to the ASE noise is changed;
measuring, in a second configuration in which a test unit that adds an ASE noise to second signal light received by the receiver is provided at upstream of the receiver between a transmitter and the receiver connected via the optical transmission network, a second OSNR of the second signal light and a second BER of the second signal light received by the receiver while changing a ratio of the second signal light to the ASE noise;
obtaining a third SNR of the second signal light to which the ASE noise is added by the test unit from the second OSNR;
obtaining a fourth SNR of the entire second configuration from the second BER;
obtaining an amount of noises in a configuration including the optical transmission network, the transmitter, and the receiver from a relationship between a reciprocal of the third SNR and a reciprocal of the fourth SNR when the ratio of the second signal light to the ASE noise is changed; and
obtaining the GSNR of the optical transmission network by subtracting the amount of the noise in the transmitter and the receiver from the amount of the noise in the configuration.

2. The measurement method according to claim 1,
wherein a conversion coefficient to be used when the SNR is obtained from the OSNR is obtained based on a relationship between a reciprocal of the first OSNR and the reciprocal of the second SNR.

3. A determination method for determining an abnormality of an optical transmission network, the determination method comprising:
obtaining a GSNR of the optical transmission network by the measurement method according to claim 1; and
determining the abnormality of the optical transmission network by comparing the GSNR of the optical transmission network with a reference value.

4. The determination method according to claim 3,
wherein the GSNR of the optical transmission network when the optical transmission network is determined to be normal at a time of opening of an optical path is set as the reference value.

5. A measurement system that measures a GSNR of an optical transmission network, the measurement system comprising:
a first configuration in which a test unit that adds an ASE noise to first signal light output from a transmitter is provided between the transmitter and a receiver directly connected without going through the optical transmission network; and
a second configuration in which a test unit that adds an ASE noise to second signal light received by the receiver is provided at upstream of the receiver between a transmitter and the receiver connected via the optical transmission network,
wherein in the first configuration,
a first OSNR of the first signal light and a first BER of the first signal light received by the receiver are measured while changing a ratio of the first signal light to the ASE noise,
a first SNR of the first signal light to which the ASE noise is added by the test unit is obtained from the first OSNR,
a second SNR of the entire first configuration is obtained from the first BER, and
an amount of noises in the transmitter and the receiver is obtained from a relationship between a reciprocal of the first SNR and a reciprocal of the second SNR when the ratio of the first signal light to the ASE noise is changed, and
in the second configuration,
a second OSNR of the second signal light and a second BER of the second signal light received by the receiver are measured while changing a ratio of the second signal light to the ASE noise,
a third SNR of the second signal light to which the ASE noise is added by the test unit is obtained from the second OSNR,
a fourth SNR of the entire second configuration is obtained from the second BER,
an amount of noises in a configuration including the optical transmission network, the transmitter, and the receiver is obtained from a relationship between a reciprocal of the third SNR and a reciprocal of the fourth SNR when the ratio of the second signal light to the ASE noise is changed, and
the GSNR of the optical transmission network is obtained by subtracting the amount of the noise in the transmitter and the receiver from the amount of the noise in the configuration.

6. The measurement system according to claim 5,
wherein a conversion coefficient to be used when the SNR is obtained from the OSNR is obtained based on a relationship between a reciprocal of the first OSNR and the reciprocal of the second SNR.
